(19) United States
(12) Patent Application Publication
(10) Pub. No.: US 2024/0239135 A1
(43) Pub. Date: Jul. 18, 2024

(54) Spinner Cap

(71) Applicant: Joeal Walden, Boston, MA (US)

(72) Inventor: Joeal Walden, Boston, MA (US)

(21) Appl. No.: 18/155,923

(22) Filed: Jan. 18, 2023

(51) Int. Cl. B60B 7/20; B60B 7/10

(52) U.S. Cl. CPC B60B 7/20; B60B 7/10

(57) ABSTRACT

The spinner cap is a device intended to enhance the appearance of an automotive wheel by giving a visual effect of a slowly rotating wheel even when the vehicle is no longer in motion. To accomplish this, the device includes a unique arrangement of parts including a spinner, a spindle, a bearing, and a cap base. The spindle connects the spinner to the bearing. The bearing enables the spinner to rotate independently of the cap base. When fully assembled, the cap base is inserted into the center bore of the wheel and secured by a plurality of spring clips that engage with the center bore. Once in place, the cap base rotates with the wheel and the spinner freely rotates independently of the wheel's rotation.

### FIELD OF THE INVENTION

The present invention relates generally to automotive wheel covers. More specifically, the present invention is a spinner cap designed to spin freely over the wheel, thereby enhancing the wheel's visual appearance.

### BACKGROUND OF THE INVENTION

Vehicle customization has been a preferred hobby and thriving industry amongst car enthusiasts. One of the biggest and easiest ways to customize a car is to change the wheels on the car. In the early 2000s, wheel customization reached new heights when spinner rims came into market. Spinner rims only came into the possession of those with the deepest pockets.

Personalization comes with trends, and trends come and go in cycles. With the exception of those living in the south, the last time the average person saw a car with spinners was in the mid-2000s. That style has left the scene, bringing under-glow lights with it. But lately, under-glow lights are making a comeback. In urban areas, it is common to see at least a few cars every week that have under-glow lights. The main reason spinners have not made a comeback yet is due to the high cost for a set of wheels.

It is therefore an objective of the present invention to provide an economical solution to bring back spinner rims. The present invention is a Spinner Cap. Spinner Caps will open the avenue to welcome spinners back into the market similar to the way LEDs ushered under-glow lights back into style. The purpose of the Spinner Cap is to provide spinners, also known as spinner rims, at an affordable cost and in wider use. At the moment, the only way a person can obtain spinner rims is to purchase an entire set of wheels that are specifically made to house a certain spinner face. Even then, the current available designs are very outdated, very expensive, and only available in extreme dimensions that are both very heavy and incompatible with most vehicles without extensive modifications. The present invention, the Spinner Cap, allows for a much wider variety of sizes, styles, and use cases at a very affordable price, offering the common enthusiast much more freedom in the customization of their vehicles, which is what enthusiasts strive for.

### SUMMARY

It is an aim of the present invention to provide a spinner for an automotive wheel that is capable of rotating independently of the wheel. The present invention is a spinner cap assembly that comprises a spinner and a cap base. The cap base takes the place of a center cap found on most vehicles. In particular, the center cap is first removed from the center bore of the wheel, and the spinner cap assembly is then inserted into the wheel's center bore. A plurality of spring clips on the cap base engages with a groove near the back of the center bore. Thus, the groove that is normally used to attach the original center cap, can now be used to secure the present invention to the wheel. Once in place, the spinner rotates freely independent of the wheel's rotation.

To accomplish this task, the spinner cap assembly further comprises a ball bearing, a bearing housing, and a spindle. The bearing is contained within the bearing housing and the bearing housing is mechanically attached to the cap base with hardware. The spindle is inserted through the center of the spinner and through the bearing. The spindle allows the spinner to rotate freely about the bearing, while the cap base and bearing housing rotate with the wheel. As an option, a spacer can be placed between the spinner and the bearing. The spacer can be of any length necessary to allow the spinner to rotate freely without contacting the cap base and/or wheel spokes.

### BRIEF DESCRIPTION OF THE DRAWINGS

FIG. 1 is a top-front perspective exploded view of the present invention, shown detached from a wheel.

FIG. 2 is a top-front perspective view of the present invention, shown attached to a wheel.

FIG. 3 is an enlarged cutaway view taken from FIG. 2, showing the means of attachment.

FIG. 4 is a top perspective exploded view of the present invention.

FIG. 5 is a bottom perspective enlarged, exploded view of the upper portion of the present invention.

FIG. 6 is a rear elevational view of the present invention.

FIG. 7 is an enlarged, cross-sectional view taken along line 7-7 in FIG. 6.

### DETAIL DESCRIPTIONS OF THE INVENTION

All illustrations of the drawings are for the purpose of describing selected versions of the present invention and are not intended to limit the scope of the present invention.

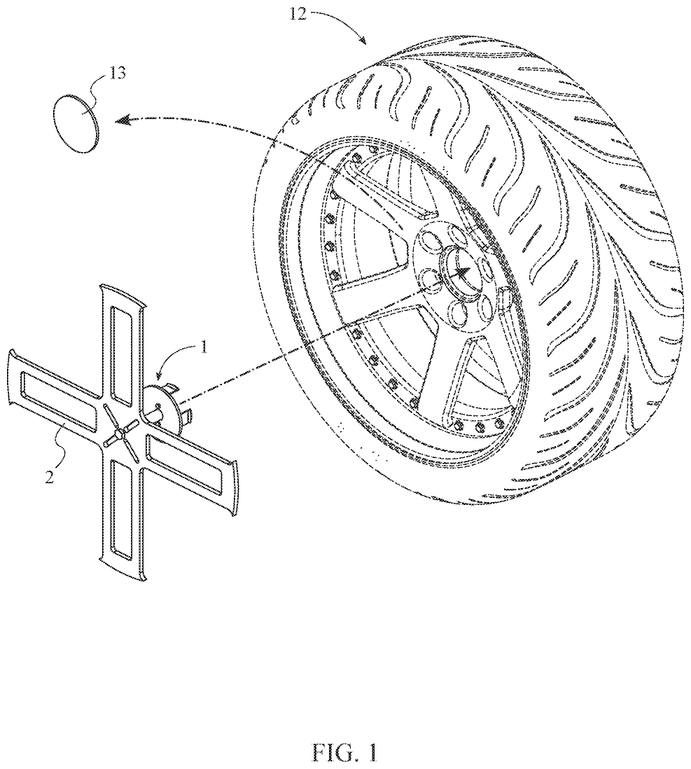

In reference to FIG. 1 through FIG. 7, the present invention is a spinner cap assembly 1 designed to removably attach to the center bore 14 of a vehicle wheel 12.

Once attached, a spinner 2 on the spinner cap assembly 1 is capable of rotating independently of the wheel rotation, with the use of a bearing 5 housed within the spinner cap assembly 1. Therefore, the spinner 2 rotates freely on the bearing 5, while the structural components of the spinner cap assembly 1 rotate with the wheel 12. As the vehicle begins to move from a stop, the spinner 2 will rotate after sufficient rotation of the wheel 12 due to the effects of wind drag and inertia. This gives a visual effect of a slowly rotating wheel. When the vehicle comes to a complete stop, the wheel 12 stops rotating, and the spinner 2 continues to rotate for a short period of time due to the inertial effects. This gives the visual effect of a wheel that continues to rotate even when the vehicle is no longer in motion.

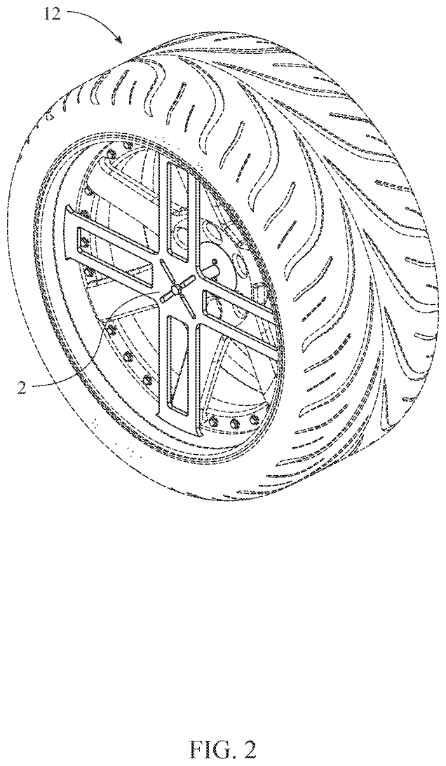

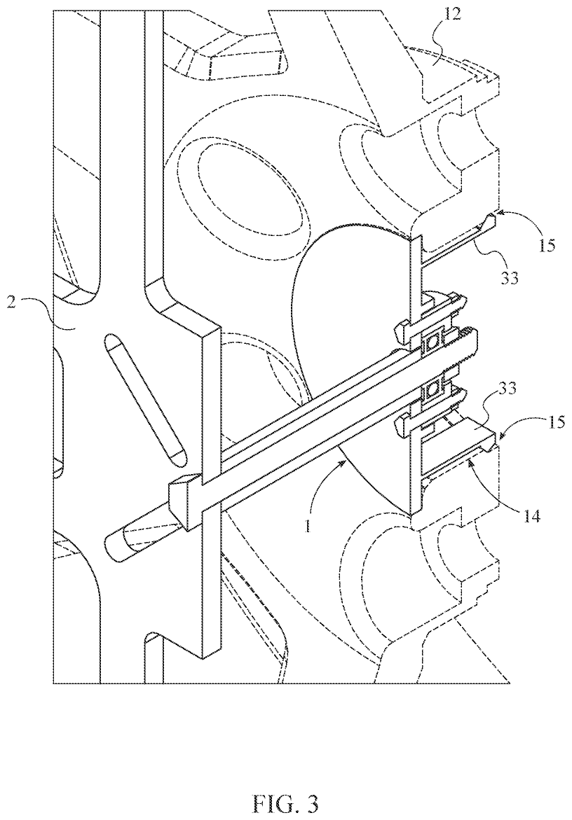

As seen in FIG. 1, the wheel 12 normally comprises a center cap 13 that covers the center bore 14 of the wheel 12. Although commonly seen as a decorative item, the primary purpose of the center cap 13 is to keep dirt away from the wheel bearings of the vehicle. For use with the present invention, the center cap 13 is removed and replaced by the spinner cap assembly 1, as seen in FIG. 2. To remove the center cap 13, any proper tool can be used (e.g., flat-head screwdriver) to carefully pry the outer edges of the center cap 13 away from the center bore 14 of the wheel 12. Once removed, the user can then insert the spinner cap assembly 1 into the center bore 14. As best seen in FIG. 3, the spinner cap assembly 1 is secured in place by gently pressing on the center until the spring clips 33 on the spinner cap assembly 1 engage with a groove 15 disposed on the wheel's center bore 14. The spinner cap assembly 1 is designed to be serviceable for customization and/or maintenance (e.g., replacement of the bearing 5). As such, the spinner cap assembly 1 can be easily removed from the wheel 12 by pulling the spinner cap assembly 1 until the spring clips 33 disengage from the groove 15.

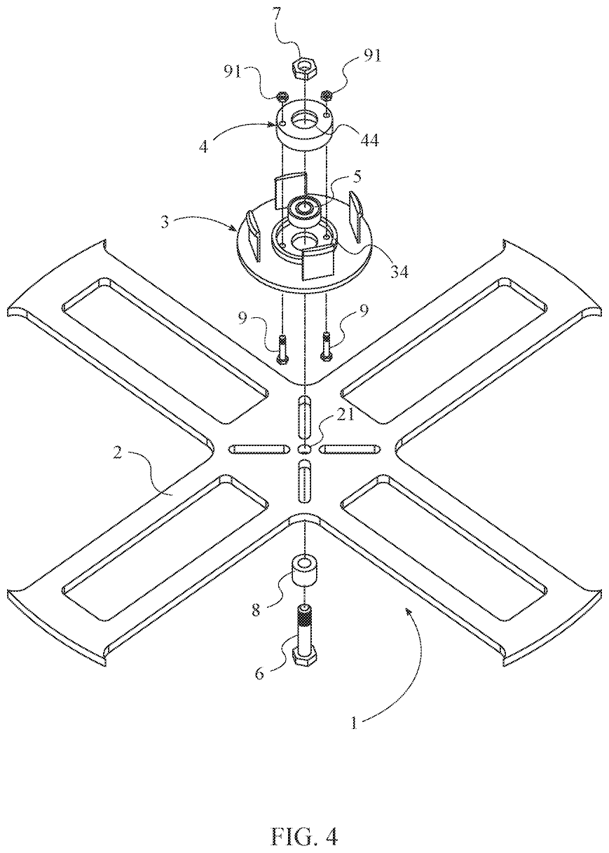

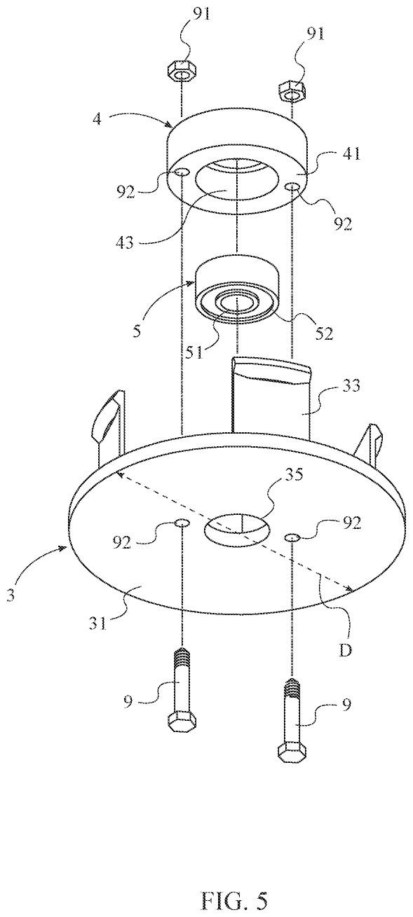

The spinner cap assembly 1 further comprises a spinner 2, a cap base 3, a bearing housing 4, a bearing 5, a spindle 6, a spindle nut 7, a spacer 8, a plurality of fasteners 9, and a plurality of hardware nuts 91. As seen in FIG. 4 through FIG. 7, the cap base 3 functions as the primary structural component of the present invention, as the remaining components of the present invention are configured upon the cap base 3. The cap base 3 further comprises a base outer surface 31, a base inner surface 32, a plurality of spring clips 33, a centering ring 34, and a cap bore 35. As best seen in FIG. 5, the cap base 3 is disk-shaped, having a diameter D defined by the center bore 14 of the wheel 12. The cap base 3 attaches to the center bore 14 via the plurality of spring clips 33. Each of the plurality of spring clips 33 is distributed along the periphery of the base inner surface 32. The positioning of each of the plurality of spring clips 33 is defined by the size of the center bore 14 of the wheel 12. The centering ring 34 is centrally disposed on the base inner surface 32. The centering ring 34 functions as a retainer for the bearing housing 4, thereby centering the bearing housing 4 with the cap base 3.

As best seen in FIG. 4, the bearing housing 4 is cylindrical in shape and slidably engages with the centering ring 34. The bearing housing 4 further comprises a housing outer surface 41, a housing inner surface 42, a cavity 43, and a housing bore 44. As best seen in FIG. 5, the cavity 43 is a cylindrically recessed space that is centrally disposed on the housing outer surface 41. The housing bore 44 is centrally disposed on the housing inner surface 42. This arrangement allows the bearing housing 4 to receive the bearing 5. As such, the bearing 5 is positioned in between the cap base 3 and the bearing housing 4. The bearing housing 4 is secured to the cap base 3 by the plurality of fasteners 9 and the plurality of hardware nuts 91. More specifically, the plurality of fasteners 9 extends through a plurality of hardware holes 92 distributed on the periphery of the cap base 3. Each of the said fasteners 9 further extend through a plurality of hardware holes 92 defined on the bearing housing 4. The plurality of hardware nuts 91 attach to the plurality of fasteners 9.

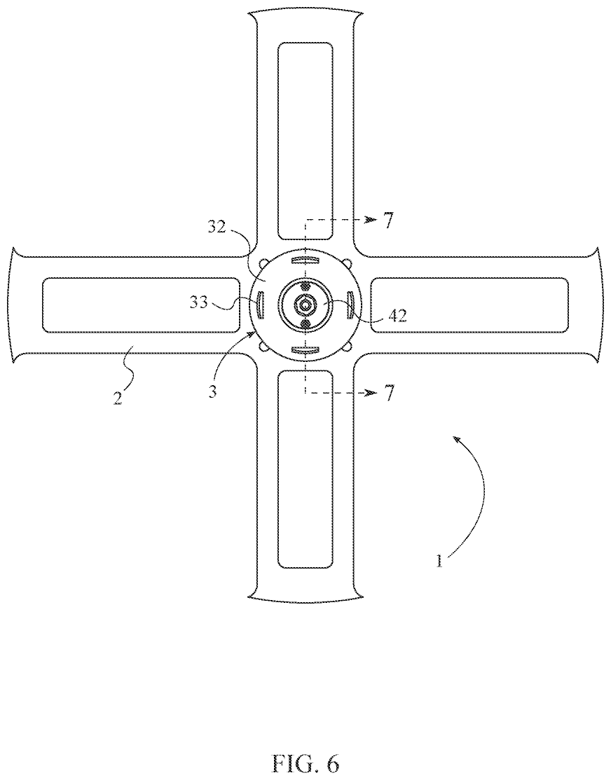

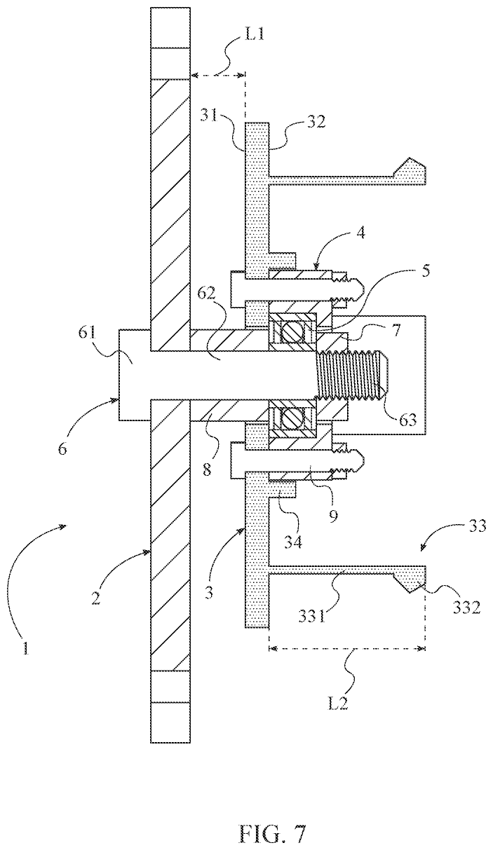

In reference to FIG. 6 and FIG. 7, the spinner 2 is secured to the bearing 5 via the spindle 6, the spacer 8, and the spindle nut 7. This arrangement allows the spinner 2 to freely rotate independent of the cap base 3. In particular, the spindle 6 first extends through a center aperture 21 defined on the spinner 2. Next, the spindle 6 passes through the spacer 8. The spacer 8 is cylindrical in shape and can be in the form of one or more washers or a collar. As best seen in FIG. 7, the spacer 8 extends from the spinner 2 to the bearing 5. Thus, the spacer 8 offsets the spinner 2 away from the cap base 3 by a predefined length L1, such that the spinner 2 can freely rotate without contacting the cap base 3 and the wheel 12. The spindle 6 then extends through the cap bore 35 centered about the cap base 3. For proper fit and clearance, the cap bore 35 is slightly larger than the spacer 8. This arrangement allows the spacer 8 to freely rotate without contacting the cap base 3. The spindle then passes through the bearing 5 and the housing bore 44, and finally secured with the spindle nut 7. For proper fit and clearance, the housing bore 44 is slightly larger than the spindle nut 7. In this arrangement, the spindle nut 7 is tightened until abutted up against the inner ring 51 of the bearing 5. Once tightened, the bearing 5 allows the spinner 2, the spacer 7, the spindle 6, and the spindle nut 7 to rotate independent of the cap base 3 and bearing housing 4.

In order to properly secure the spinner cap assembly 1 to the wheel 12, each of the plurality of spring clips 33 further comprises a tab 331, a tab length L2, and a retainer nub 332. As seen in FIG. 7, the tab 331 is positioned along the periphery of the base inner surface 32, extending outward opposite of the cap base 3. The tab length L2 is defined by the positioning of the groove 15 located on the center bore 14 of the wheel 12. The retainer nub 332 is terminally connected to the tab 331 and extends radially outward. As best seen in FIG. 3, the retainer nub 332 on each of the spring clips 33 slidably engages with the groove 15 on the center bore 14, thereby securing the spinner cap assembly 1 to the wheel 12.

In order to secure the spinner 2 to the spinner cap assembly 1, the spindle 6 further comprises a head 61, a shank 62, and a threaded end 63. As best seen in FIG. 7, the head 61 can be either bolt-type or screw-type. Preferably, the shank 62 has a smooth journal portion that extends from the head 61 through the bearing 5. In this way, surface contact between the shank 62 and the bearing 5 is maximized, thereby reducing wear and tear on the bearing 5. The threaded end 63 extends beyond the shank 62. This arrangement allows the spindle 6 to be secured to the bearing 5 via the spindle nut 7.

The bearing 5 may be any conventionally available ball bearing of suitable size for engaging a cylindrical shaft, having an inner ring 51 and an outer ring 52.

The spinner 2 may be of any size and shape designed to fit on the wheel 12. The materials of the various parts of the spinner cap assembly 1 are preferably high strength plastic. However, the material of the various parts are not limited to plastic, and can be made of any other material based on design, user, and/or manufacturing requirements.

Although the invention has been explained in relation to its preferred embodiment, it is to be understood that many other possible modifications and variations can be made without departing from the spirit and scope of the invention.

What is claimed is:

1. A spinner cap for a wheel comprising:
a spinner;
an aperture disposed in a center of the spinner;
a cap base;
a bearing housing;
a bearing;
a spindle;
a spindle nut;
the cap base comprising a base outer surface, a base inner surface, a plurality of spring clips, and a cap bore;
the cap bore being centrally disposed on the cap base;
the bearing housing comprising a housing outer surface, a housing inner surface, a cavity, and a housing bore;
the housing bore being centrally disposed on the bearing housing;
the bearing being disposed in the cavity;
the bearing housing being concentrically connected to the cap base;
the spindle being inserted through the aperture of the spinner, through the cap bore, through the bearing, and through the housing bore;
the spindle securing the spinner to the bearing via the spindle nut;
the cap base being concentrically attached to a center bore of the wheel by means of the plurality of spring clips engaging with the center bore; and
the spinner freely rotates independently of the wheel.

2. The spinner cap for a wheel as claimed in claim 1 comprising:
the cap base being disk-shaped;
the plurality of spring clips being distributed about the periphery of the base inner surface; and
each of the plurality of spring clips positioned perpendicular to the base inner surface.

3. The spinner cap for a wheel as claimed in claim 2 comprising:
each of the plurality of spring clips comprising a tab and a retainer nub;
the tab being terminally connected to the base inner surface;
the tab extending outward to a predefined length;
the retainer nub being terminally connected to the tab; and
the retainer nub extending radially outward.

4. The spinner cap for a wheel as claimed in claim 2 comprising:
the cap base comprising a centering ring;
the centering ring being concentrically disposed on the base inner surface;
the centering ring extending outward; and
the bearing housing slidably engaging with the centering ring.

5. The spinner cap for a wheel as claimed in claim 1 comprising:
the bearing housing being cylindrically-shaped;
the cavity being a cylindrically recessed space; and
the cavity traversing axially inward from the housing outer surface.

6. The spinner cap for a wheel as claimed in claim 1 comprising:
a plurality of hardware holes, a plurality of fasteners, and a plurality of hardware nuts;
the plurality of hardware holes being distributed about the periphery of the cap base and the periphery of the bearing housing;
the plurality of fasteners extending through the plurality of hardware holes; and
the plurality of fasteners attaching the bearing housing to the cap base via the plurality of hardware nuts.

7. The spinner cap for a wheel as claimed in claim 1 comprising:
a spacer;
the spacer being cylindrically-shaped;
the spindle being inserted through the spacer; and
the spacer being positioned between the spinner and the bearing.

8. The spinner cap for a wheel as claimed in claim 1 comprising:
the spindle comprising a head, a shank, and a threaded end;
the shank having a smooth journal portion;
the shank extending from the head and through the bearing; and
the threaded end extending from the shank.

9. The spinner cap for a wheel as claimed in claim 8 comprising:
the bearing being a ball-type bearing;
the bearing comprising an inner ring and an outer ring; and
the inner ring rotating independently of the outer ring.

10. A spinner cap for a wheel comprising:
a spinner;
an aperture disposed in a center of the spinner;
a cap base;
a bearing housing;
a bearing;
a spindle;
a spindle nut;
the cap base comprising a base outer surface, a base inner surface, a plurality of spring clips, and a cap bore;
the cap base being disk-shaped;
the plurality of spring clips being distributed about the periphery of the base inner surface;
each of the plurality of spring clips positioned perpendicular to the base inner surface;
the cap bore being centrally disposed on the cap base;
the bearing housing comprising a housing outer surface, a housing inner surface, a cavity, and a housing bore;
the bearing housing being cylindrically-shaped;
the cavity being a cylindrically recessed space;
the cavity traversing axially inward from the housing outer surface;
the housing bore being centrally disposed on the bearing housing;
the bearing being disposed in the cavity;
the bearing housing being concentrically connected to the cap base;
the spindle being inserted through the aperture of the spinner, through the cap bore, through the bearing, and through the housing bore;
the spindle securing the spinner to the bearing via the spindle nut;
the cap base being concentrically attached to a center bore of the wheel by means of the plurality of spring clips engaging with the center bore; and
the spinner freely rotates independently of the wheel.

11. The spinner cap for a wheel as claimed in claim 10 comprising:
each of the plurality of spring clips comprising a tab and a retainer nub;
the tab being terminally connected to the base inner surface;
the tab extending outward to a predefined length;
the retainer nub being terminally connected to the tab; and
the retainer nub extending radially outward.

12. The spinner cap for a wheel as claimed in claim 10 comprising:
the cap base comprising a centering ring;
the centering ring being concentrically disposed on the base inner surface;
the centering ring extending outward; and
the bearing housing slidably engaging with the centering ring.

13. The spinner cap for a wheel as claimed in claim 10 comprising:
a plurality of hardware holes, a plurality of fasteners, and a plurality of hardware nuts;
the plurality of hardware holes being distributed about the periphery of the cap base and the periphery of the bearing housing;
the plurality of fasteners extending through the plurality of hardware holes; and
the plurality of fasteners attaching the bearing housing to the cap base via the plurality of hardware nuts.

14. The spinner cap for a wheel as claimed in claim 10 comprising:
a spacer;
the spacer being cylindrically-shaped;
the spindle being inserted through the spacer; and
the spacer being positioned between the spinner and the bearing.

15. The spinner cap for a wheel as claimed in claim 10 comprising:
the spindle comprising a head, a shank, and a threaded end;
the shank having a smooth journal portion;
the shank extending from the head and through the bearing; and
the threaded end extending from the shank.

16. The spinner cap for a wheel as claimed in claim 15 comprising:
the bearing being a ball-type bearing;
the bearing comprising an inner ring and an outer ring; and
the inner ring rotating independently of the outer ring.

17. A spinner cap for a wheel comprising:
a spinner;
an aperture disposed in a center of the spinner;
a cap base;
a bearing housing;
a bearing;
a spindle;
a spindle nut;
a spacer;
the cap base comprising a base outer surface, a base inner surface, a plurality of spring clips, a cap bore, and a centering ring;
the cap base being disk-shaped;
the plurality of spring clips being distributed about the periphery of the base inner surface;
each of the plurality of spring clips positioned perpendicular to the base inner surface;
the cap bore being centrally disposed on the cap base;
the centering ring being concentrically disposed on the base inner surface;
the centering ring extending outward;
the bearing housing slidably engaging with the centering ring;
the bearing housing comprising a housing outer surface, a housing inner surface, a cavity, and a housing bore;
the bearing housing being cylindrically-shaped;
the cavity being a cylindrically recessed space;
the cavity traversing axially inward from the housing outer surface;
the housing bore being centrally disposed on the bearing housing;
the bearing being disposed in the cavity;
the bearing housing being concentrically connected to the cap base;
the spacer being cylindrically-shaped;
the spacer being positioned between the spinner and the bearing;
the spindle being inserted through the aperture of the spinner, through the spacer, through the cap bore, through the bearing, and through the housing bore;
the spindle securing the spinner to the bearing via the spindle nut;
the cap base being concentrically attached to a center bore of the wheel by means of the plurality of spring clips engaging with the center bore; and
the spinner freely rotates independently of the wheel.

18. The spinner cap for a wheel as claimed in claim 17 comprising:
each of the plurality of spring clips comprising a tab and a retainer nub;
the tab being terminally connected to the base inner surface;
the tab extending outward to a predefined length;
the retainer nub being terminally connected to the tab; and
the retainer nub extending radially outward.

19. The spinner cap for a wheel as claimed in claim 17 comprising:
a plurality of hardware holes, a plurality of fasteners, and a plurality of hardware nuts;
the plurality of hardware holes being distributed about the periphery of the cap base and the periphery of the bearing housing;
the plurality of fasteners extending through the plurality of hardware holes; and
the plurality of fasteners attaching the bearing housing to the cap base via the plurality of hardware nuts.

20. The spinner cap for a wheel as claimed in claim 17 comprising:
the spindle comprising a head, a shank, and a threaded end;
the shank having a smooth journal portion;
the shank extending from the head and through the bearing;
the threaded end extending from the shank;
the bearing being a ball-type bearing;
the bearing comprising an inner ring and an outer ring; and
the inner ring rotating independently of the outer ring.
